(19) United States
(12) Patent Application Publication
(10) Pub. No.: US 2025/0266924 A1
(43) Pub. Date: Aug. 21, 2025

(54) SYSTEMS AND METHODS OF ADJUSTING CODEC BIT RATE

(71) Applicant: Meta Platforms Technologies, LLC, Menlo Park, CA (US)

(72) Inventors: Liwen Yu, Santa Clara, CA (US); Ping Wang, Redmond, WA (US); Yee Sin Chan, San Francisco, CA (US); Xiaodi Zhang, San Ramon, CA (US)

(73) Assignee: Meta Platforms Technologies, LLC, Menlo Park, CA (US)

(21) Appl. No.: 19/026,341

(22) Filed: Jan. 16, 2025

Related U.S. Application Data
(60) Provisional application No. 63/554,191, filed on Feb. 16, 2024.

(51) Int. Cl. H04L 1/00

(52) U.S. Cl. CPC H04L 1/0009; H04L 1/0002

(57) ABSTRACT

Systems and methods of adjusting a codec rate may include a wireless communication endpoint which estimates an uplink rate for a wireless communication node, based on a grant provided by the wireless communication node to the wireless communication endpoint. The wireless communication endpoint may send information relating to the estimated uplink rate to an application of the wireless communication endpoint. The wireless communication endpoint may transmit, to the wireless communication node, one or more packets generated using a codec rate configured by the application according to the information relating to the estimated uplink rate.

### CROSS-REFERENCE TO RELATED APPLICATIONS

This application claims the benefit of and priority to U.S. Provisional Application No. 63/554,191, filed Feb. 16, 2024, the contents of which are incorporated herein by reference in its entirety.

### FIELD OF DISCLOSURE

The present disclosure is generally related to wireless communication, including but not limited to, systems and methods of adjusting a codec bit rate.

### BACKGROUND

Augmented reality (AR), virtual reality (VR), and mixed reality (MR) are becoming more prevalent, which such technology being supported across a wider variety of platforms and device. Some AR/VR/MR devices may communicate with one or more other remote devices via a cellular connection.

### SUMMARY

In one aspect, this disclosure relates to a method, including estimating, by a wireless communication endpoint, an uplink rate for a wireless communication node, based on a grant provided by the wireless communication node to the wireless communication endpoint. The method may include sending, by the wireless communication endpoint, information relating to the estimated uplink rate to an application of the wireless communication endpoint. The method may include transmitting, by the wireless communication endpoint to the wireless communication node, one or more packets generated using a codec rate configured by the application according to the information relating to the estimated uplink rate.

In some embodiments, the grant includes an uplink grant, including at least one of one or more configured grants or one or more dynamic grants. In some embodiments, estimating the uplink rate includes estimating an average uplink data rate within a time period, based on a sum of the one or more configured grants and the one or more dynamic grants over the time period. In some embodiments, the method includes determining, by the wireless communication endpoint, the time period based on the application, or one or more services of the application. In some embodiments, the grant includes a downlink grant, including at least one of one or more configured grants or one or more semi-persistent scheduling grants. In some embodiments, the application decreases the codec rate from a first codec rate to a second codec rate, responsive to the estimated uplink rate being less than the first codec rate. In some embodiments, the wireless communication endpoint includes a first wireless communication device, and the application is executing on a second wireless communication device communicably coupled to the first wireless communication device. In some embodiments, the method includes determining, by the application of the wireless communication endpoint, whether to modify the codec rate, according to the information relating to the estimated uplink rate.

In some embodiments, the method includes determining, by the application of the wireless communication endpoint, to increase the codec rate or maintain the codec rate, responsive to the estimated uplink rate being greater than, or greater than or equal to, the first codec rate, or determining, by the application of the wireless communication endpoint, to decrease the codec rate, responsive to the estimated uplink rate being less than, or less than or equal to, the first codec rate. In some embodiments, the application includes an extended reality (XR) application. In some embodiments, the one or more packets include one or more second packets, and the method further includes transmitting, by the wireless communication endpoint at a first time instance prior to estimating the load, one or more first packets including data encoded by the application at a first codec rate. In some embodiments, the information relating to the estimated uplink rate comprises at least one of the estimated uplink rate, an indication to increase or decrease the codec rate, or a target codec rate.

In another aspect, this disclosure relates to a wireless communication device, including a transceiver and one or more processors configured to estimate an uplink rate on a wireless communication node, based on an uplink grant provided by the wireless communication node to the wireless communication device. The one or more processors may be configured to send information relating to the estimated uplink rate to an application of the wireless communication endpoint. The one or more processors may be configured to transmit, via the transceiver to the wireless communication node, one or more packets having a codec rate configured by the application according to the information relating to the estimated uplink rate.

In some embodiments, the uplink grant includes at least one of one or more configured grants or one or more dynamic grants, and estimating the uplink rate includes estimating an average uplink data rate within a time period, based on a sum of the one or more configured grants and the one or more dynamic grants over the time period. In some embodiments, the one or more processors are further configured to determine the time period based on the application, or one or more services of the application. In some embodiments, the application is configured to decrease the codec rate from a first codec rate to a second codec rate, responsive to the estimated uplink rate being less than the first codec rate. In some embodiments, the one or more processors are further configured to execute the application to determine whether to modify the codec rate, according to the information relating to the estimated uplink rate. In some embodiments, the one or more processors are further configured to execute the application, configured to determine to increase the codec rate or maintain the codec rate, responsive to the estimated uplink rate being greater than, or greater than or equal to, the first codec rate; or determine to decrease the codec rate, responsive to the estimated uplink rate being less than, or less than or equal to, the first codec rate.

In yet another aspect, this disclosure relates to a non-transitory computer readable medium storing instructions that, when executed by one or more processors, cause the one or more processors to execute an application. The application may be configured to receive, from a device, information relating to an estimated uplink rate on a wireless communication node, the device determining the estimated uplink rate based on an uplink grant provided by the wireless communication node to the device. The application may be configured to determine a codec rate for generating one or more packets, based on the information related to the estimated uplink rate. The application may be configured to generate the one or more packets using the determined codec rate, for transmission by the device to the wireless communication node.

In some embodiments, the application is configured to determine to modify the codec rate, from a first codec rate to a second codec rate, based on the estimated uplink rate as compared to the first codec rate.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system for adjusting a codec rate, according to an example implementation of the present disclosure.

FIG. 6 is a flowchart showing an example method of dynamically adapting a codec rate according to an estimated uplink rate, according to an example implementation of the present disclosure.

FIG. 7 is a flowchart showing an example method of adjusting a codec bit rate, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

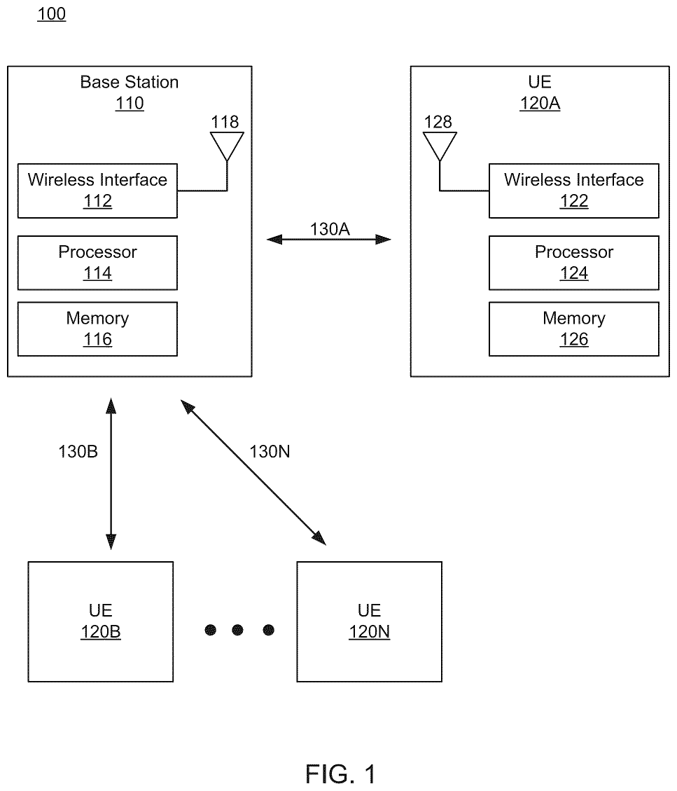

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

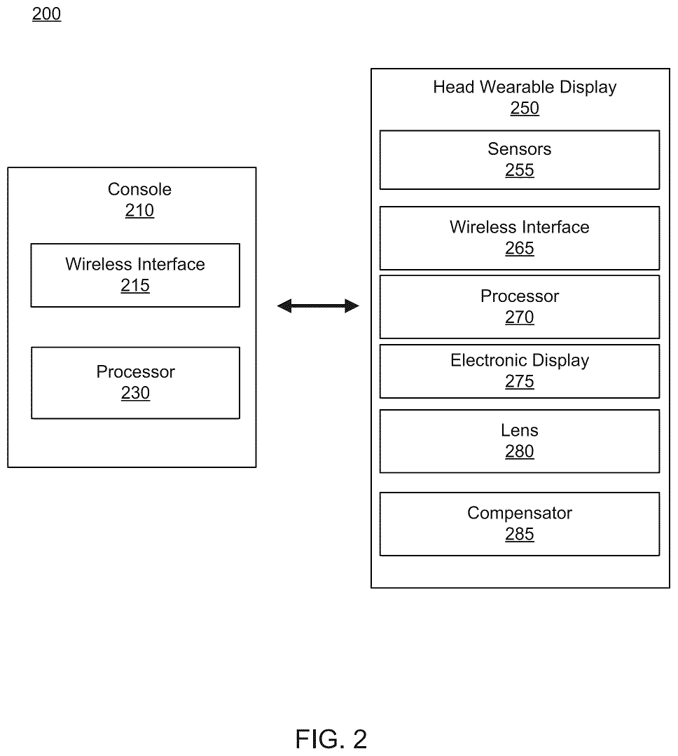

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

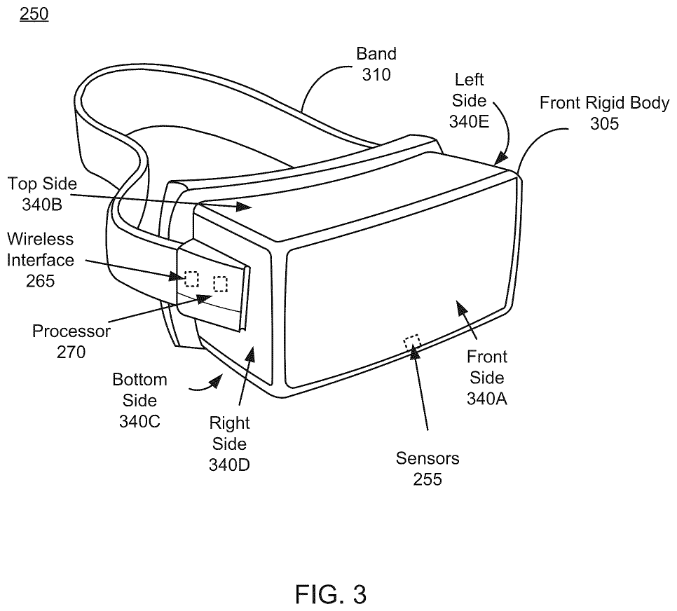

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

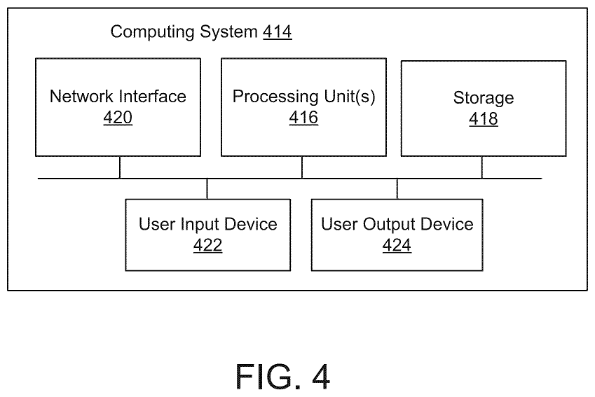

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Referring generally to the FIGURES submitted herewith, this disclosure relates to systems and methods for using indications of congestion severity to adapt application bitrate (e.g., codec bitrate). For an augmented reality (AR)/virtual reality (VR) service/application, low latency and/or high throughput may be important to deliver/provide satisfactory user experience. An AR/VR application may use, leverage, or employ application layer media codec bitrate adaptation and transport layer congestion control to achieve low latency and/or high throughput transmission. Some network congestion control may rely on end-to-end network delay/loss metrics to detect congestion, which may take at least one round-trip time (RTT) for a sender to detect congestion and adapt transmission bit rate. In a wireless network, a device may experience channel fluctuations and load dynamics. Unpredictable throughput fluctuations in a cellular uplink may affect an accuracy of transport layer bitrate estimation and congestion control. As such, it can be beneficial for a cellular base station (BS) and a user equipment (UE) to coordinate and signal to an application to adapt its bitrate in an effective and timely manner.

The systems and methods of the present solution address the above-identified technical problems by utilizing uplink scheduling grants information. Cellular physical (PHY)/medium access control (MAC) information on a device side may provide support for uplink quality-aware codec adaptation of the AR/XR service. In some embodiments, a wireless communication endpoint, such as a UE (e.g., its modem) or application server, may determine an uplink (UL) quality/capacity based on uplink scheduling grants information (e.g., configured grants, dynamic grants) given by the network (e.g., BS) to the wireless communication endpoint for a configured time window. The uplink scheduling grants information may be obtained according to a resource block (RB), transport block size (TBS), and/or modulation and coding scheme (MCE). The wireless communication endpoint may estimate the UL capacity to determine if the UL capacity is overloaded or underloaded with respect to the current codec rate. If a scheduling grant provision by the BS within a time window is more than the data generated by an application, the UL can be underloaded. If a scheduling grant provision by the BS within a time window is less than the data generated by an application, the UL can be overloaded. If the UL is overloaded or underloaded, the controller may adjust or maintain a target codec rate for the codec. Accordingly, the systems and methods for indicating congestion severity described herein may provide a quick and effective detection solution to mitigate network congestion and to support latency-sensitive extended reality (XR) traffic (by utilizing an uplink grant metric).

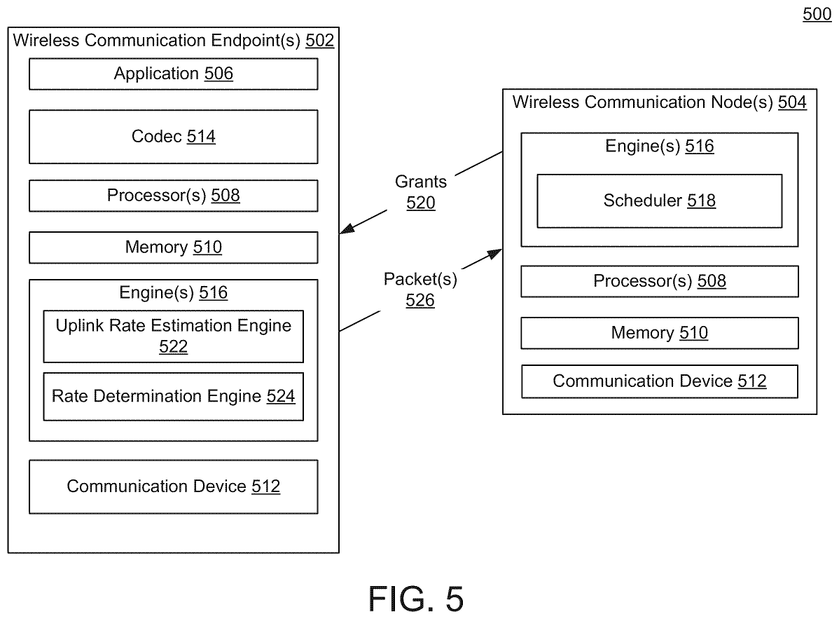

Referring to FIG. 5, depicted is a block diagram of a system 500 for adjusting a codec rate, according to an example implementation of the present disclosure. The system 500 may include elements, hardware, or components similar to those described above with reference to FIG. 1-FIG. 4. For example, the system 500 may include one or more wireless communication endpoints 502 and one or more wireless communication nodes 504. The endpoint(s) 502 may be similar to the user equipment 120, console 210, and/or head wearable display 250 described above with reference to FIG. 1-FIG. 4, and/or an application server which is hosting one or more resources/services/applications 506 executable by the endpoint(s) 502. In other words, and in various embodiments, the endpoint(s) 502 may be or include an application server and/or user equipment (e.g., in a peer-to-peer communication session and/or in communication with an application server). The wireless communication node(s) 504 may be, include, or be similar to the base station 110 described above with reference to FIG. 1.

The endpoint(s) 502 and wireless communication node(s) 504 may include respective processor(s) 508, memory 510, communication device(s) 512. The processor(s) 508 may be the same as or similar to the processors 114, 124, 230, 270 and/or processing unit(s) 416 described above with reference to FIG. 1-FIG. 4. The memory 510 may be the same as or similar to memory 116, 126, and/or storage 418 described above with reference to FIG. 1-FIG. 4. The communication device 512 may be the same as or similar to the wireless interface 112, 122, 215, 265 (e.g., in combination with or communicably coupled to antenna 118, 128) and/or network interface 420 described above with reference to FIG. 1-FIG. 4.

The endpoint(s) 502 may include a codec 514, which may include one or more encoders and decoders. The codec 514 may be configured to generate, configure, establish, derive, or otherwise encode (e.g., for the encoder, and correspondingly decode, for the decoder) the data into a format for transmission to another endpoint 502. In some embodiments, the codec 514 may be or include a video codec used for encoding and decoding video data. For example, in the context of video data, the video encoder may be configured to apply compression to the video data (e.g., using a video codec, such as H.264, H.265, AV1, etc.), to generate encoded video packets. Similarly, the video decoder may be configured to decompress encoded video packets using a video decoder, for consumption/use thereby. While the example of video data is described herein, other types or forms of codecs may be used by the endpoints for reformatting/encoding/decoding other types of data. In some embodiments, the codec 514 may be a codec of the application 506. For example, the codec 514 may be implemented at the application layer of the endpoint 502 in connection with execution of the application 506 to encode/decode the data.

The endpoint(s) 502 and wireless communication node(s) 504 may include various processing engine(s) 516. The processing engine(s) 516 may be or include any device, component, element, or hardware designed or configured to perform one or more of the functions described herein. For example, the wireless communication node(s) 504 may include a scheduler 518 configured to schedule one or more resource grants 520 (referred to generally as grants) for the endpoint endpoint(s) 502. The endpoint(s) 502 may include an uplink rate estimation engine 522 and a rate determination engine 524. While certain processing engine(s) 516 are shown and described herein, it should be understood that additional and/or alternative processing engine(s) 516 may be implemented on the endpoint(s) 502 and/or wireless communication node(s) 504. Additionally, two or more of the processing engine(s) 516 may be implemented as a single processing engine 516. Furthermore, one of the processing engine(s) 516 may implemented as multiple processing engines 516.

As described in greater detail below, the uplink rate estimation engine 522 may be configured to determine, identify, or otherwise estimate a uplink rate on the wireless communication node 504, based on one or more grant(s) provided by the wireless communication node 504 to the endpoint 502. The rate determination engine 524 may be configured to identify or otherwise determine a codec rate based on the estimated uplink rate, which is provided to the application for generating packet(s) for transmission via the wireless communication node 504 to another endpoint, according to the estimated uplink rate.

As shown in FIG. 5, the endpoint 502 may include an application 506. While shown as being included on the endpoint 502, in various embodiments, the application 506 may in some embodiments at least partially execute on a paired device. For example, the endpoint 502 may be or include the console 210 of FIG. 2, and the application 506 may be at least partially executed on the head wearable display 250 of FIG. 2. The application 506 may be or include any type or form of application, resource, or service executable on the endpoint 502 which may involve generation of and transmission to, or receipt from and consumption by, data between the endpoint 502 and another endpoint 502 using the wireless communication node(s) 504. For example, the application 506 may be or include an extended reality (XR) application, video/audio call or conferencing application, gaming application, and so forth. Where execution of the application 506 involves generation of data for transmission to another endpoint (e.g., via the wireless communication node 504), the endpoint 502 may be configured to request a scheduling grant from the wireless communication node 504 (e.g., by transmitting a scheduling request to the wireless communication node 504). The scheduling request may be or include an uplink control message generated by the communication device 512 of the endpoint 502. This scheduling request may include, carry, identify, otherwise provide various information relating to the requested grants, such as a Buffer Status Report (BSR), traffic patterns corresponding to traffic which is to be sent according to the grants, information about the priority of the data, QoS requirements associated with the application 506, and/or timing constraints.

The wireless communication node 504 may include a scheduler 518. The scheduler 518 may be designed or configured to select, determine, or otherwise configure one or more grants 520 to an endpoint 502, based on the scheduling requests received from various endpoints 502 served by the wireless communication node 504. In particular, the scheduler 518 may be configured to configure the grants to respective communication devices 512 of the endpoints 502 (e.g., at the physical layer of the endpoints 502), according to the scheduling requests. The grants 520 may be or include resource allocations provided by the wireless communication node 504 to the endpoint 502. The grants 520 may indicate, identify, configure, or otherwise specify usage by the endpoint 502 of radio resources for communication, such as frequency resources (e.g., specific frequencies or sub-carriers), time resources (e.g., time slots or subframes), transmission power levels, Modulation and Coding Scheme (MCS), retransmission protocols (e.g., hybrid automatic repeat request (HARQ) processes), and/or QoS parameters.

The grants 520 may be or include different types or forms of grants, depending on the scheduling request from the endpoint(s) 502. For example, the grants 520 may include configured grants 520, dynamic grants 520, and/or semi-persistent scheduling grants 520. The scheduler 518 may be configured to determine the type of grant 520, based on the scheduling requests received from the endpoint 502 and/or whether the scheduling request is for downlink or uplink traffic. For example, for a scheduling request indicating sporadic data traffic or a buffer overflow, the scheduler 518 may be configured to select a dynamic grant for the endpoint 502 to address immediate transmission needs. As another example, for the scheduling request tied to an application 506 that transmits data uplink (or downlink) periodically, the scheduler 518 may select a configured grant to provide for regular uplink transmissions without repetitive scheduling requests. Similarly, for a scheduling request relating to recurring downlink traffic, such as video streaming or voice calls, the scheduler 518 may select a semi-persistent scheduling grant.

The wireless communication endpoint 502 may include an uplink rate estimation engine 522 and a rate determination engine 524. As described in greater detail below, the uplink rate estimation engine 522 may be configured to determine or estimate an uplink rate on the wireless communication node 504, based on the grant(s) from the wireless communication node 504. The rate determination engine 524 may be configured to select or otherwise determine a rate for the codec 514, based on the estimated uplink rate. While shown as included in the engine(s) 516, in some embodiments, the uplink rate estimation engine 522 may be embodied or executed at the physical layer (e.g., by the communication device 512 or a controller/processor 508/compute device communicably coupled to the communication device 512), and the rate determination engine 524 may be embodied or executed at the application layer (e.g., by the application 506 or a controller/processor 508/compute device executing the application 506).

The uplink rate estimation engine 522 may be designed or configured to identify, determine, or otherwise estimate an uplink rate for the wireless communication node 504. In some embodiments, the uplink rate determination engine 522 may be configured to estimate the uplink rate for a time window or time period. The uplink rate determination engine 522 may be configured to determine the time period based on the application 506, and/or based on one or more services of the application 506. In some embodiments, the application 506 may provide the time period to the uplink rate determination engine 522 (e.g., by on-device signaling). In some embodiments, the application 506 may provide information relating to (e.g., used for determining) the time period to the uplink rate determination engine 522 (e.g., application type, services or functionalities being used by the application 506, etc.).

As some examples, the time period may be larger or smaller, based on particular QoS requirements and/or power consumption relating to sampling and changing of codec rate. For example, having a shorter time period may increase the frequency of determining/estimating the uplink rate, which may result in increased power consumption but may also increase the granularity in determination of codec rate (e.g., thereby resulting in finer tuning and better overall QoS). Similarly, having a longer time period may decrease the frequency of determining/estimating the uplink rate, which may result in decreased power consumption at the expense of less granularity and potential impact of QoS.

The uplink rate estimation engine 522 may be configured to estimate the uplink rate (e.g., an estimated maximum uplink data rate) for the time period. In some embodiments, the uplink rate estimation engine 522 may be configured to estimate the uplink rate for the time period, based on a sum of each of the grants 520 from the wireless communication node 504. For example, where the scheduler 518 provides both configured and/or dynamic grants 520 to the wireless communication endpoint 502 (or both configured and/or semi-persistent scheduling grants 520), the uplink rate estimation engine 522 may be configured to estimate the uplink rate based on the sum of the grants 520 which are provided by the scheduler 518.

In some embodiments, the uplink rate estimation engine 522 may be configured to estimate the uplink rate by computing a sum of the resources allocated in the grants 520, across all grants 520 from the scheduler 518. The uplink rate estimation engine 522 may be configured to estimate the uplink rate by aggregating the resource allocations from different grant types, such as configured grants, dynamic grants, and/or semi-persistent scheduling grants. As noted above, each grant 520 may specify/indicate the resources allocated in terms of time slots, frequency resources, and MCS. The uplink rate estimation engine 522 may be configured to combine/aggregate the information from the grants 520, to calculate the total available uplink resources. In some embodiments, the uplink rate estimation engine 522 may be configured to apply a respective weight to different grant types. Such weights may be between 0 and 1, depending on the types of grants 520. In some embodiments, the uplink rate estimation engine 522 may be configured to determine an effective data throughput per resource block (e.g., time slot and frequency resource), by incorporating the MCS values associated with the grants. The uplink rate estimation engine 522 may be configured to determine/estimate the uplink rate (e.g., maximum uplink data rate) as a function of the total resource allocation and the throughput per resource block (e.g., by multiplying the total resource allocation and throughput per resource block). For example, and in some embodiments, the uplink rate estimation engine 522 may be configured to determine or estimate the uplink rate using Equation 1 below:

$$UL = \frac{a ( {\sum }_{i = 0}^{n} {CG}_{i} ) + b ( {\sum }_{i = 0}^{m} {DG}_{i} )}{T} . \qquad Equation 1$$

Where UL is the estimated average UL data rate over the time period T, a and b are weighting parameters, CG are configured grants, and DG are dynamic grants. It should be understood that Equation 1 may be adapted for other types or forms of grants, including semi-persistent scheduling grants.

The rate determination engine 524 may be designed or configured to determine, identify, or otherwise select a codec rate for generating packet(s) 526, according to the estimated uplink rate. In some embodiments, the rate determination engine 522 may be configured to apply the estimated uplink rate to one or more switching criterion, for determining/selecting the codec rate. Various selection criterion are described in greater detail below. The rate determination engine 524 may be configured to provide the selected/identified/determined codec rate to the application 506, such that the codec 514 generates various packets/frames/protocol data units (PDUs) according to the selected codec rate.

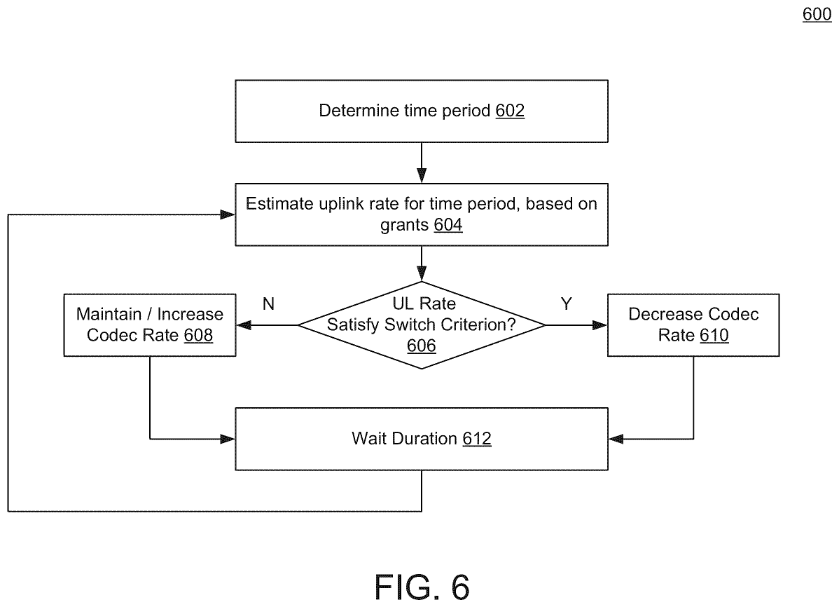

Referring now to FIG. 6, depicted is a flowchart showing an example method 600 of dynamically adapting a codec rate according to an estimated uplink rate, according to an example implementation of the present disclosure. The method 600 may be executed, performed, or otherwise implemented on the endpoints 502 described above. As a brief overview, at step 602, the endpoint 502 may determine a time period. At step 604, the endpoint 502 may estimate an uplink rate for the time period, based on grants. At step 606, the endpoint 502 may determine whether the uplink rate satisfies a switch criterion. At step 608, the endpoint 502 may maintain or increase the codec rate. At step 610, the endpoint 502 may decrease the codec rate. At step 612, the endpoint 502 may wait a duration until it repeats the method 600.

At step 602, the endpoint 502 may determine a time period. In some embodiments, the uplink rate estimation engine 522 may determine the time period, based on information received from the application 506. For example, the information from the application 506 may include the time period itself, an identifier of the application 506 or an application type of the application 506 which is used for determining the time period, an identifier or information relating to one or more services (or resources) of the application 506 which are used (e.g., voice, video, audio, sensing, etc.), and so forth. The endpoint 502 may, in some embodiments, determine the time period based on information relating to traffic which is sent or to be sent to a wireless communication node. For example, the endpoint 502 may determine the time period based on types of traffic included/identified/corresponding to a buffer status report, scheduling request, or other signaling used for requesting resource allocations from a wireless communication network (e.g., the wireless communication node 504).

The endpoint 502 may further receive various grants 520 from the scheduler 518. For example, the endpoint 502 may generate and transmit various scheduling requests to the wireless communication node 504. The endpoint 502 may generate and transmit the scheduling requests, responsive to determining to transmit data/information/packets to the wireless communication node 504. The endpoint may transmit the scheduling requests to the scheduler 518, for the scheduler 518 to correspondingly send grants 520 to the endpoint 502. As described above, the scheduler 518 may transmit various types or forms of grants 520 to the endpoint 502, based on the scheduling requests. For example, the grants 520 may include configured grants, dynamic grants 520, and/or semi-persistent scheduling grants.

At step 604, the endpoint 502 may estimate an uplink rate for the time window, based on grants. In some embodiments, the uplink rate estimation engine 524 may estimate the uplink rate for the time window, based on the grants 520 received from the wireless communication node 504 (e.g., from the scheduler 518). The uplink rate estimation engine 524 may estimate the uplink rate for the time window, by computing a sum (or otherwise aggregating) the resources allocated in the grants. The uplink rate estimation engine 524 may further determine an estimated throughput per resource block (e.g., using an MCS and/or other information signaled in the grants 520 and corresponding to throughput). The uplink rate estimation engine 524 may determine the estimated uplink rate based on the aggregated resources allocated in the grants 520 and the estimated throughput per resource block (e.g., by multiplying the aggregated resources and estimated throughput). In some embodiments, the uplink rate estimation engine 524 may be configured to determine the estimated uplink rate using Equation 1 above.

At step 606, the endpoint 502 may determine whether the uplink rate satisfies a switch criterion. The endpoint may apply the estimated uplink rate and a current codec rate to one or more switch criterion, to determine whether to maintain, increase, or decrease the codec rate (e.g., used by the codec 514) for generating packet(s) 526 for transmission to the wireless communication node 504. In some embodiments, the switch criterion may be or include a comparison of the uplink rate to the codec rate. For example, the switch criterion may indicate to maintain the codec rate, responsive to the uplink rate being equal to or greater than (e.g., within a threshold greater than) the codec rate. Such an implementation may provide for stable transmission quality by preventing unnecessary adjustments when the uplink rate is sufficient to support the current codec rate. As another example, the switch criterion may indicate to increase the codec rate, responsive to the uplink rate being a threshold greater than (e.g., by or exceeding the threshold) the codec rate. Such an implementation may allow the endpoint 502 to improve transmission quality and corresponding QoS, such as by increasing audio or video resolution, when the network conditions can support a higher estimated data rate than what is being used by the application 506 using the current codec rate. As still another example, the switch criterion may indicate to decrease the codec rate, responsive to the uplink rate being less than (or less than or equal to) the codec rate. Such implementations may reduce/prevent transmission disruptions or packet loss by adapting to reduced network capacity.

At step 608, the endpoint 502 may maintain or increase the codec rate. At step 610, the endpoint 602 may decrease the codec rate. In some embodiments, the rate determination engine 524 may maintain, increase, or decrease the codec rate, based on or according to the comparison of the uplink rate and the codec rate as applied to the switch criterion at step 606. The rate determination engine 524 may transmit, communicate, or otherwise send a signal to the application 506 to cause switching of the codec rate. In some embodiments, the rate determination engine 524 may transmit the signal which indicates the determined codec rate. In some embodiments, the rate determination engine 524 may transmit the signal which indicates to increase or decrease the codec rate.

Following step 608, the application 506 may receive information corresponding to the estimated uplink rate. In some embodiments, the information may include the estimated uplink rate. In such implementations, the rate determination engine 524 may be implemented or executed at the application 506, and steps 606 through 610 may be performed by the application 506 (e.g., the rate determination engine 524 of the application 506). In some embodiments, the information may include instructions to increase or decrease the codec rate, or the determined codec rate itself. In such implementations, the rate determination engine 524 may be implemented at a different layer (e.g., the physical layer of the endpoint 502 or an intermediary layer between the physical layer or application layer). Correspondingly, the application 506 may determine, set, or otherwise configure the codec rate based on the instructions from the rate determination engine 524 (e.g., increase or decrease the codec rate relative to the current codec rate), or set the codec rate based on the codec rate signaled to the application 506.

At step 612, the endpoint 502 may wait a duration until it repeats the method 600. In some embodiments, the endpoint 502 may wait a duration to repeat steps 604 through 610. For example, the duration may be or include the time window, a multiple or factor of the time window, etc. In other words, the method 600 may be at least partially re-executed at various intervals. Correspondingly, the uplink rate estimation engine 522 may iteratively update the estimated uplink rate, based on grants 520 from the scheduler 518, to correspondingly adapt the codec rate over time.

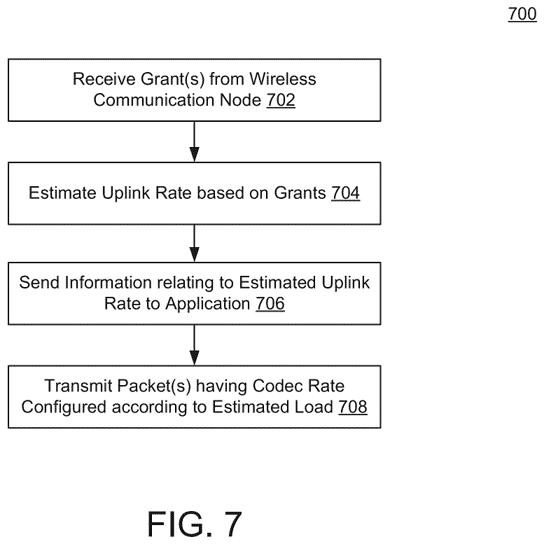

Referring now to FIG. 7, depicted is a flowchart showing an example method 700 of adjusting a codec bit rate, according to an example implementation of the present disclosure. The method 700 may be performed, executed on, or otherwise implemented by the devices, components, elements, or hardware described above with reference to FIG. 1-FIG. 5. As a brief overview, at step 702, a wireless communication endpoint may receive one or more grants from a wireless communication node. At step 704, the wireless communication endpoint may estimate an uplink rate based on the grant(s). At step 706, the wireless communication endpoint may send information relating to the estimated uplink rate to an application. At step 708, the wireless communication endpoint may transmit packets having a codec rate configured according to the estimated uplink rate.

At step 702, a wireless communication endpoint may receive one or more grants from a wireless communication node. In some embodiments, the wireless communication endpoint may receive the grants from the wireless communication node, responsive to transmission of one or more scheduling requests to the wireless communication node requesting such corresponding grants. The wireless communication endpoint may transmit the scheduling requests responsive to determining to transmit data to the wireless communication node (e.g., uplink or downlink data). For example, the wireless communication endpoint may transmit the scheduling request responsive to an application/resource/service generating data for transmission to the wireless communication node, responsive to launching of an application which is to trigger transmission of data, etc. The wireless communication nodes may determine, select, or otherwise configure the grants for the wireless communication endpoint based on the scheduling request and/or network conditions. The wireless communication node may configure the grants to allocate network resources to the wireless communication node. In some embodiments, the wireless communication node may configure various types of grants, including configured grants, dynamic grants, and/or semi-persistent scheduling grants. The wireless communication node may select the type of grant to use for a scheduling request, based on the type of traffic, whether the traffic is uplink or downlink traffic, periodicity of the traffic, etc.

At step 704, the wireless communication endpoint may estimate an uplink rate based on the grant(s). In some embodiments, the wireless communication endpoint may estimate an uplink rate for the wireless communication node, based on the grant(s) provided by the wireless communication node to the wireless communication endpoint at step 702. In some embodiments, the wireless communication endpoint may estimate the uplink rate for a time period (e.g., an average estimated uplink data rate over the time period). The wireless communication endpoint may estimate the uplink rate based on a sum of the grants (e.g., configured grants, dynamic grants, and/or semi-persistent scheduling grants) over the time period. The wireless communication endpoint may determine the time period based on the application, or one or more services of the application. For example, the wireless communication endpoint may determine the time period based on signaling from the application indicating the time period, indicating or identifying the application or application type (which the wireless communication endpoint determines the time period based on the application/application type), indicating or identifying one or more services (e.g., voice, video, audio, file transfer, etc.) of the application (e.g., which are to be used in connection with execution of the application). In some embodiments, the wireless communication endpoint may determine the time period using, based on, or according to Equation 1 above.

At step 706, the wireless communication endpoint may send information relating to the estimated uplink rate to an application. In some embodiments, the wireless communication endpoint may send information relating to the estimated uplink rate to an application of the wireless communication endpoint. The information may include the estimated uplink rate used by the application to determine whether to modify the codec rate. Additionally or alternatively, the information may include a target or requested codec rate, and/or changes to the codec rate, determined based on the estimated uplink rate.

In some embodiments, the wireless communication endpoint may determine whether to update, modify, decrease, increase, or maintain the codec rate used for generating packets for transmission, based on the estimated uplink rate. Such determination may be made at various layers of the wireless communication endpoint, including the physical layer (e.g., by a transceiver or communication device), the application layer (e.g., by the application or a codec of the application), or any intervening layer (e.g., by various processors, controllers, compute devices of the wireless communication endpoint or a paired wireless communication endpoint.

In some embodiments, the application may determine whether to modify the codec rate, according to the information relating to the estimated uplink rate. For example, the estimated uplink rate may be determined at the hardware layer, and the application may receive the estimated uplink rate and use the estimated uplink rate for determining whether to modify the codec rate. The application may determine whether to modify the codec rate, based on a comparison of the codec rate to the estimated uplink rate. As one example, the application may determine to increase the codec rate or maintain the codec rate, responsive to the estimated uplink rate being greater than (or greater than or equal to) the codec rate. As another example, the application may determine to decrease the codec rate, responsive to the estimated uplink rate being less than (or less than or equal to) the codec rate.

At step 708, the wireless communication endpoint may transmit packets having a codec rate configured according to the estimated uplink rate. In some embodiments, the wireless communication endpoint may transmit, to the wireless communication node, one or more packets configured, generated, or otherwise provided using the codec rate configured by the application according to the information relating to the estimated uplink rate. In some embodiments, the wireless communication endpoint may generate (e.g., the application may generate) the packets using the updated/modified/configured codec rate, which is updated/modified/configured according to the estimated uplink rate. Accordingly, as the estimated uplink rate changes (e.g., based on different grants), the application may correspondingly update the codec rate for generation of subsequent packet(s) that are to be transmitted to the wireless communication node.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
estimating, by a wireless communication endpoint, an uplink rate for a wireless communication node, based on a grant provided by the wireless communication node to the wireless communication endpoint;
sending, by the wireless communication endpoint, information relating to the estimated uplink rate to an application of the wireless communication endpoint; and
transmitting, by the wireless communication endpoint to the wireless communication node, one or more packets generated using a codec rate configured by the application according to the information relating to the estimated uplink rate.

2. The method of claim 1, wherein the grant comprises an uplink grant, comprising at least one of one or more configured grants or one or more dynamic grants.

3. The method of claim 2, wherein estimating the uplink rate comprises estimating an average uplink data rate within a time period, based on a sum of the one or more configured grants and the one or more dynamic grants over the time period.

4. The method of claim 3, further comprising determining, by the wireless communication endpoint, the time period based on the application, or one or more services of the application.

5. The method of claim 1, wherein the grant comprises a downlink grant, comprising at least one of one or more configured grants or one or more semi-persistent scheduling grants.

6. The method of claim 1, wherein the application decreases the codec rate from a first codec rate to a second codec rate, responsive to the estimated uplink rate being less than the first codec rate.

7. The method of claim 1, wherein the wireless communication endpoint comprises a first wireless communication device, and the application is executing on a second wireless communication device communicably coupled to the first wireless communication device.

8. The method of claim 1, further comprising determining, by the application of the wireless communication endpoint, whether to modify the codec rate, according to the information relating to the estimated uplink rate.

9. The method of claim 8, further comprising:
determining, by the application of the wireless communication endpoint, to increase the codec rate or maintain the codec rate, responsive to the estimated uplink rate being greater than, or greater than or equal to, the codec rate; or
determining, by the application of the wireless communication endpoint, to decrease the codec rate, responsive to the estimated uplink rate being less than, or less than or equal to, the codec rate.

10. The method of claim 1, wherein the application comprises an extended reality (XR) application.

11. The method of claim 1, wherein the one or more packets comprise one or more second packets, the method further comprising:
transmitting, by the wireless communication endpoint at a first time instance prior to estimating the uplink rate, one or more first packets including data encoded by the application at a first codec rate.

12. The method of claim 1, wherein the information relating to the estimated uplink rate comprises at least one of the estimated uplink rate, an indication to increase or decrease the codec rate, or a target codec rate.

13. A wireless communication endpoint, comprising:
a transceiver; and
one or more processors configured to:
estimate an uplink rate on a wireless communication node, based on an uplink grant provided by the wireless communication node to the wireless communication endpoint;
send information relating to the estimated uplink rate to an application of the wireless communication endpoint; and
transmit, via the transceiver to the wireless communication node, one or more packets having a codec rate configured by the application according to the information relating to the estimated uplink rate.

14. The wireless communication endpoint of claim 13, wherein the uplink grant comprises at least one of one or more configured grants or one or more dynamic grants, and wherein estimating the uplink rate comprises estimating an average uplink data rate within a time period, based on a sum of the one or more configured grants and the one or more dynamic grants over the time period.

15. The wireless communication endpoint of claim 14, wherein the one or more processors are further configured to determine the time period based on the application, or one or more services of the application.

16. The wireless communication endpoint of claim 13, wherein the application is configured to decrease the codec rate from a first codec rate to a second codec rate, responsive to the information relating to the estimated uplink rate being less than the first codec rate.

17. The wireless communication endpoint of claim 13, wherein the one or more processors are further configured to execute the application to determine whether to modify the codec rate, according to the information relating to the estimated uplink rate.

18. The wireless communication endpoint of claim 17, wherein the one or more processors are further configured to execute the application, configured to:
determine to increase the codec rate or maintain the codec rate, responsive to the estimated uplink rate being greater than, or greater than or equal to, the codec rate; or
determine to decrease the codec rate, responsive to the estimated uplink rate being less than, or less than or equal to, the codec rate.

19. A non-transitory computer readable medium storing instructions that, when executed by one or more processors, cause the one or more processors to execute an application, the application configured to:
receive, from a device, information relating to an estimated uplink rate on a wireless communication node, the device determining the estimated uplink rate based on an uplink grant provided by the wireless communication node to the device;
determine a codec rate for generating one or more packets, based on the information related to the estimated uplink rate; and
generate the one or more packets using the determined codec rate, for transmission by the device to the wireless communication node.

20. The non-transitory computer readable medium of claim 19, wherein the application is configured to:
determine to modify the codec rate, from a first codec rate to a second codec rate, based on the estimated uplink rate as compared to the first codec rate.
